(19) United States
(12) Patent Application Publication
(10) Pub. No.: US 2003/0088479 A1
(43) Pub. Date: May 8, 2003

(54) Online scheduling system

(76) Inventors: Carl E. Wooten, Edgewood, KY (US); Eric S. Vail, Edgewood, KY (US)

Correspondence Address: DINSMORE & SHOHL, LLP, 1900 CHEMED CENTER, 255 EAST FIFTH STREET, CINCINNATI, OH, 45202, US

(21) Appl. No.: 10/262,676

(22) Filed: Oct. 1, 2002

Related U.S. Application Data
(60) Provisional application No. 60/326,334, filed on Oct. 1, 2001.

(51) Int. Cl. G06F 17/60

(52) U.S. Cl. 705/26

(57) ABSTRACT

Online scheduling systems comprise a scheduling module having an electronic calendar showing a plurality of time slots. The scheduling modules have executable instructions that transmit the electronic calendar to and receive scheduling data from one or more buyer and seller interfaces in order to facilitate the scheduling of a consultation between a buyer and a seller. The online scheduling systems also comprise a feedback module in communication with the scheduling module. The feedback module has executable instructions configured to receive feedback data from a buyer interface following a scheduled consultation.

### REFERENCE TO RELATED APPLICATIONS

This application claims benefit to U.S. Provisional Application No. 60/326,334 filed Oct. 1, 2001.

### TECHNICAL FIELD OF THE INVENTION

The present invention relates to an online scheduling system, and more particularly to a system and method of providing an online scheduling system which facilitates the scheduling of a consultation between a seller and a buyer such that at the time of the scheduled consultation the seller has an opportunity to sell a particular product to the buyer.

### BACKGROUND OF THE INVENTION

In many industries in the free market, sellers contact buyers for the purpose of soliciting products and services. For example, in the pharmaceutical industry, pharmaceutical companies provide prescription drugs to physicians for prescription to the physician's patients. To ensure that physicians are aware of a particular company's prescription drug selection, pharmaceutical drug companies rely on sales representatives to solicit the drugs to physicians. Sales representatives typically sell in a geographic region and/or by a particular type of drug.

Due to the large number of competitors in the industry, and the volume of prescription drugs available on the market, there are typically a large number of pharmaceutical sales representatives vying to meet with, or schedule appointments with physicians. To attract the interests of physicians, pharmaceutical sales representatives often provide nominal perks such as dinner or other paraphernalia in exchange for a brief meeting with the physician. However, due to their busy schedules, physicians typically do not want to meet with sales representatives they are unfamiliar with, or representatives soliciting products of no interest. As a result, many times it is difficult for sales representatives to schedule consultations with a particular physician.

In light of the traditional approach of pharmaceutical sales representatives vying for an opportunity to meet with a physician, it would be advantageous to provide a system that allowed physicians the opportunity to provide a schedule of available time for meeting with pharmaceutical sales representatives, without having to be constantly interrupted with calls from these sellers. Also, it would be advantageous to have a system that allowed pharmaceutical sales representatives the opportunity to schedule consultations from a list of time that the physician has designated as being available for consultation. In this way, the system would provide an orderly method of allowing pharmaceutical sales representatives to schedule consultations with physicians without constant intrusion on the part of the sales representatives. Finally, it would also be advantageous to provide a system that collected data relating to the consultation between the physician and the sales representative. The data could be used by the sales representative to improve the sales presentation, or by the pharmaceutical companies to determine which sales representatives have superior selling approaches, or for any other variety of uses.

### SUMMARY OF THE INVENTION

One embodiment of the present invention is an online scheduling system that comprises a scheduling module having an electronic calendar having a plurality of time slots. The scheduling module comprises executable instructions configured to transmit the electronic calendar to and receive scheduling data from one or more buyer and seller interfaces in order to facilitate a scheduling of a consultation between a buyer and a seller. The online scheduling system also comprises a feedback module in communication with the scheduling module. The feedback module comprises executable instructions configured to receive feedback data from a buyer interface following a scheduled consultation.

Another embodiment of the present invention is a method of collecting data. The method comprises the steps of transmitting to a seller interface an electronic calendar comprising scheduling data indicative of one or more available time slots of a buyer for a scheduled consultation. The method also comprises the step of receiving scheduling data from the seller interface comprising a seller's selection of one or more available time slots on the electronic calendar for scheduling a consultation. Lastly the method comprises the step of receiving feedback data from the buyer after the scheduled consultation.

Another embodiment of the present invention is a computer readable medium containing instructions for controlling a computer system for providing an online scheduling system. The computer readable medium comprises the instructions of transmitting to a seller interface an electronic calendar comprising scheduling data indicative of one or more available time slots of a buyer for a scheduled consultation. The computer readable medium comprises the instructions of receiving scheduling data from the seller interface comprising a seller's selection of one or more available time slots on the electronic calendar for scheduling a consultation. Lastly, the computer readable medium comprises the instructions of receiving feedback data from the buyer after the scheduled consultation.

Yet another embodiment of the present invention is a network-based method for providing an on-line scheduling system. The method comprises the steps of providing a web-site accessible by at least one buyer and at least one seller. Also, transmitting to a seller interface an electronic calendar comprising scheduling data indicative of one or more available time slots of a buyer for a scheduled consultation. The method also includes the step of receiving scheduling data from the seller interface comprising a seller's selection of one or more available time slots on the electronic calendar for scheduling a consultation and receiving feedback data from the buyer after the scheduled consultation.

Still other objects, advantages and novel features of the present invention will become apparent to those skilled in the art from the following detailed description, which is simply, by way of illustration, various modes contemplated for carrying out the invention. As will be realized, the invention is capable of other different aspects all without departing from the invention. Accordingly, the drawings and descriptions are illustrative in nature and not restrictive.

### BRIEF DESCRIPTION OF THE DRAWINGS

While the specification concludes with claims particularly pointing out and distinctly claiming the present invention, it is believed that the same will be better understood from the following description, taken in conjunction with the accompanying drawings, in which:

FIG. 1 depicts an exemplary embodiment of an online scheduling system in accordance with the present invention;

FIG. 2 depicts a schematic overview of the exemplary embodiment of the online scheduling system as depicted in FIG. 1;

FIG. 3 illustrates an exemplary screen shot of a buyer's electronic calendar in accordance with the present invention as transmitted to a buyer's interface;

FIG. 4 illustrates an exemplary screen shot of a buyer's electronic calendar in accordance with the present invention as transmitted to a seller's interface;

FIG. 5 depicts a more detailed exemplary embodiment of the online scheduling system as depicted in FIGS. 1 and 2; and

FIG. 6 depicts an exemplary method of using an online scheduling system in accordance with the present invention.

### DETAILED DESCRIPTION OF EXEMPLARY EMBODIMENTS

Reference will now be made in detail to various embodiments of the invention, various examples of which are illustrated in the accompanying drawings, wherein like numerals indicate corresponding elements throughout the views.

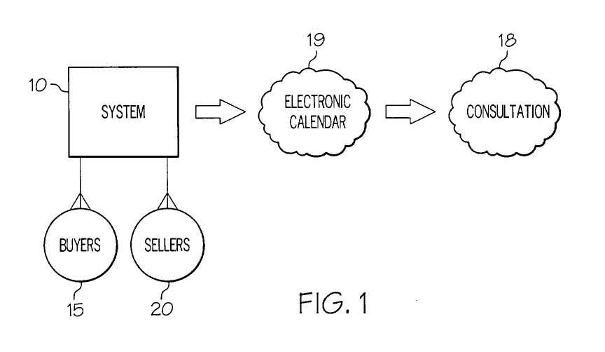

FIG. 1. depicts an exemplary embodiment of an online scheduling system 10 in accordance with the present invention. In particular, the online scheduling system 10 of the present invention provides an electronic vehicle for buyers 15 of products and/or services to set up an electronic calendar 19 having time slots available for selection by one or more sellers 20. The online scheduling system 10 facilitates scheduling of a consultation 18 between a seller 20 and a buyer 15 such that at the time of the scheduled consultation the seller has an opportunity to sell a particular product to the buyer. It should be recognized by those skilled in the relevant art that such a scheduling system 10 could be advantageously provided in virtually any industry where sellers 20 contact buyers 15 for the purpose of selling a particular product. In a particular exemplary embodiment, however, the present invention may be directed to the pharmaceutical sales industry where pharmaceutical sales representatives sell prescription drugs to physicians.

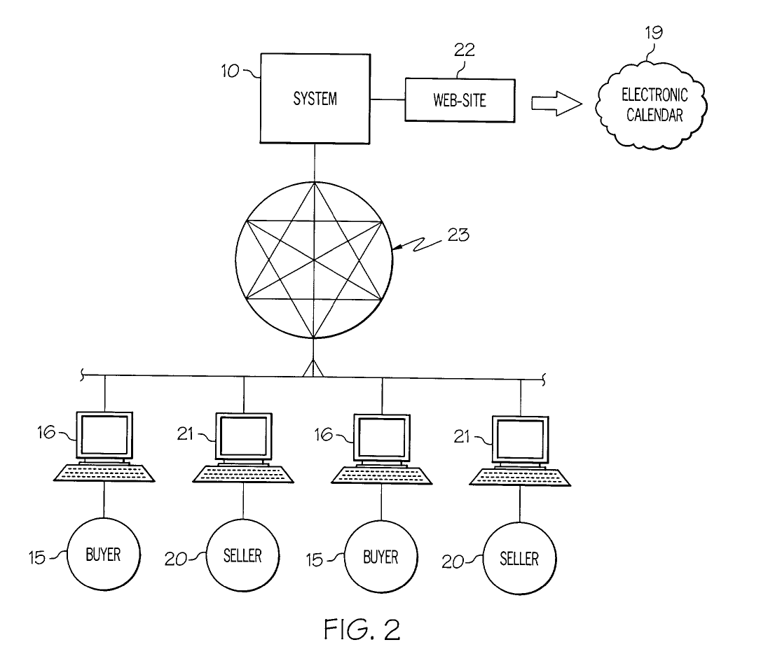

In an exemplary embodiment of the invention, such as that depicted in FIG. 2, the online scheduling system 10 of the present invention is operated through a web-site 22 hosted on a network 23, such as a wide-area network, local-area network, or the Internet. In such an embodiment, the online scheduling system 10 is capable of being accessed by a plurality of buyers 15 and sellers 20 at any time for the purpose of scheduling a consultation 18 between a buyer 15 and a seller 20. In particular, a buyer 15, such as a physician, could access the system 10 for the purpose of setting-up and/or modifying an electronic calendar 19 hosted on the system 10. The buyer sets-up the electronic calendar 19 indicating time slots that are available for consultation with sellers 20. Thereafter, a seller 20, such as a pharmaceutical sales representative, accesses the system 10 for the purpose of signing-up for one or more available time slots as indicated by the seller on the electronic calendar 19.

As further depicted in FIG. 2, an exemplary embodiment of the present invention, the online scheduling system 10 is in communication with, or is accessible by one or more buyers 15, such as physicians, via a buyer interface 16. The buyer interface 16 is configured to receive and display information transmitted from the system 10 and is configured to accept and transmit buyer input to the system 10. For example, information transmitted to a buyer interface 16 from the system 10 for display might include an electronic calendar 19 showing a plurality of time slots or showing one or more time slots selected by a seller 20 for scheduling a consultation. Input transmitted by a buyer 15, such as a physician, to the system 10 via a buyer interface 16 might include scheduling data, an exclusion list of pharmaceutical representatives the physician will not see, and feedback data relating to the physician/pharmaceutical sales representative consultation.

As also depicted in FIG. 2. the online scheduling system 10 of the present invention is in communication with, or is accessible by one or more sellers 20, such as pharmaceutical sales representatives, via a seller interface 21. Like the buyer interface 16, the seller interface 21 is configured to receive and display information transmitted by the system 10 and is configured to accept and transmit seller input to the system 10. For example, information transmitted to a seller interface 21 for display might include an electronic calendar 19 of a buyer showing a plurality of time slots. Input transmitted by a seller 20 to the system 10 via a seller interface 21 might include scheduling data such as selections of one or more available time slots or correspondence relating to trading a time slot with another seller.

In a non-limiting embodiment of the invention, a buyer interface 16 and/or seller interface 21 might comprise a kiosk, computer, personal digital assistant (PDA), a device with wireless application programs (WAP) such as a cell phone, interactive TV, an Internet appliance, or other access device. In one relatively common exemplary embodiment, the interfaces 16, 21 may comprise a computer system having a CPU, memory, a visual display device and a keyboard or other input device such as a mouse or joystick Additionally, such interfaces should be configured with an Internet connection through a communication link and running a web browser such as Internet Explorer from Microsoft Corp. or Netscape Navigator from Netscape Communications Corp.

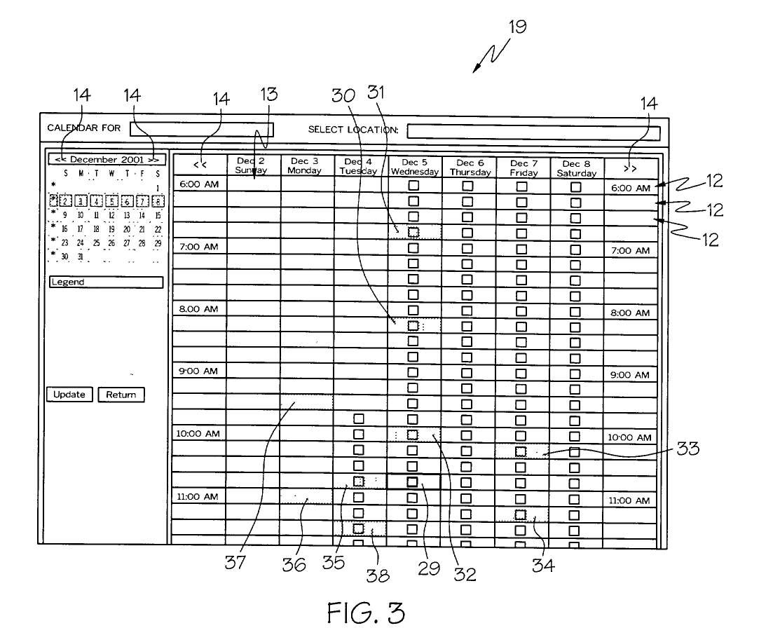

FIG. 3 illustrates an exemplary screen shot of a buyer's electronic calendar 19 in accordance with the present invention as transmitted to the buyer or physician interface 16. In particular, an electronic calendar 19 has a plurality of time slots 12 depicted in 15 minute increments that are set-up on the quarter hour. Each electronic calendar 19 depicts time slots 12 between a specified set of hours during a seven day work week that a buyer can designate as “available” for scheduling a consultation. It should be recognized that the time slots 12 could be configured in any other increment such as, by way of example only, 10 minute, 20 minute or half-hour intervals and the time slots could be depicted in any combination including up to 24 hours a day, 7 days a week.

In an exemplary embodiment of the invention, a display of the electronic calendar 19 at a buyer interface 16 indicates the status of a particular time slot, such as, but not limited to being available 29, unavailable 30, booked 31 overbooked 32, confirmed 33, cancelled 34, traded 35, not-paid 36, completed 37, and tentative 38, or any combination thereof. Available time slots 29 are those that the buyer has indicated are available for scheduling a consultation. Unavailable time slots 30 are those that the buyer has indicated are unavailable for scheduling a consultation. Booked time slots 31 are those that the buyer has indicated as being available and that a seller has selected for scheduling a consultation. Overbooked time slots 32 are those that the buyer has indicated as being available and that more than one seller has selected for scheduling a consultation. Confirmed time slots 33 are those that the seller has confirmed his/her presence at a consultation's scheduled date and time. Cancelled 34 time slots are those that either the buyer or seller has indicted an inability to attend. Traded time slots 35 indicate that one seller has traded his time slot with another seller. Not-paid time slots 36 are the buyer's indication of which completed consultations he/she has not received payement. Completed time slots 37 indicate a consultation that has taken place and tentative time slots 38 are those that have been provisionally booked by a seller. It should be recognized that any number of various status indications could be added or modified without departing from the scope of the invention and that obvious modifications might be desired.

It should be recognized from the foregoing that only a portion of the status of the time slots on an electronic calendar 19 are set-up and/or modified by the buyer, and the remaining status of time slots are based on the selections of the seller. In particular, a buyer sets-up and maintains the electronic calendar 19 by inputting scheduling data 13 to indicate the status of a particular time slot 12 such as available 29 or unavailable 30. The buyer can also input scheduling data 13 to cancel an already scheduled consultation. Sellers input scheduling data 13 to select one or more time slots indicated by a buyer as being available. A seller's selection of an available time slot results in the status of the time slot being indicated as booked 31. If a time slot is booked 31 and another seller selects the same time slot, the status of the time slot is indicated as overbooked 32. Sellers can also input scheduling data 13 to cancel an already scheduled consultation.

In an exemplary embodiment of the invention, the system is configured to allow the buyer to set-up the electronic calendar 19 for as many days or months as desired. For example, a buyer may not wish to have appointments scheduled out more than three months due to uncertainty in their availability. As a result, the system 10 is configurable on a buyer-by-buyer basis as to the time frame for allowing sellers to schedule a consultation. Additionally, it should be recognized that the electronic calendar 19 will be configured to be user friendly and that obvious modifications to the system will be added over time. For example, in one embodiment of the invention, buyers might be capable of copying scheduling data 13 from one day to the next, one week to the next, or one month to the next. Moreover, the system may be configured to allow for automatic scheduling of appointments on a month-to-month basis of sellers that the buyer wants to see on a regular basis. Additionally, the electronic calendar 19 could be programmed in virtually any number of ways to display an adequate electronic calendar that is capable of being manipulated or modified by a plurality of users. For example, the electronic calendar 19 might comprise a plurality of icons 14 that allow for easy manipulation of the calendar or allow the calendar 19 to be displayed on a day-by-day, week-by-week, or month-by-month basis.

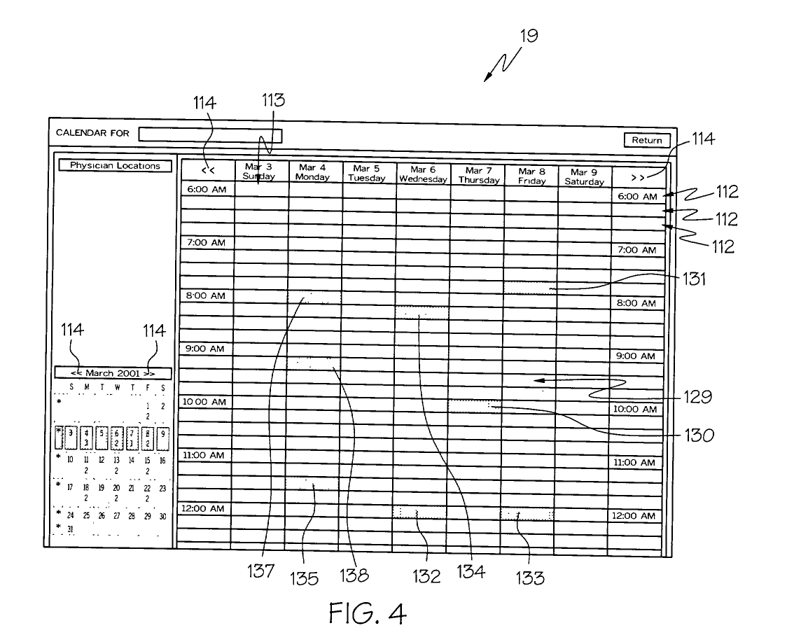

FIG. 4 illustrates an exemplary screen shot of a buyer's electronic calendar 19 in accordance with the present invention as transmitted to the seller's or pharmaceutical sales representative's interface 21. Like the buyer's display, the electronic calendar 19 transmitted and displayed at the seller's interface 21 has a plurality of time slots 112 depicted in 15 minute increments that are set-up on the quarter hour. Also, like the buyer's display, the electronic calendar 19 depicts time slots 112 between a specified set of hours and on a seven day work week for scheduling consultations. Once again, it should be recognized that the time slots 112 could be configured in any other increment such as, by way of example only, 10 minute, 20 minute or half-hour increments and the time slots could be shown in any combination including up to 24 hours a day, 7 days a week.

In an exemplary embodiment of the invention, the electronic calendar 19 transmitted to the seller interface 21 indicates whether a particular time slot is available 129, unavailable 130, booked 131 overbooked 132, confirmed 133, cancelled 134, traded 135, tentative 138, or completed 137, or any combination thereof. In this embodiment, a seller will view a particular buyer's electronic calendar 19 and schedule one or more consultations with the buyer. The seller will input scheduling data 113 by selecting a particular time slot 112 that is indicated as available, even if it has been booked by another seller for scheduling a consultation with a buyer. It is also contemplated that sellers will be capable of indicating a desired month, week, or day to consult with a particular buyer. For example, if a buyer's calendar only goes out one month, but the seller desires to meet with the buyer in three months, the system 10 will allow the seller to tentatively schedule a time slot on the electronic calendar. These time slots will be displayed to the buyer and the seller as tentative 138.

From the foregoing, it should be recognized that the electronic calendar 19 will automatically display the status of the time slots on the electronic calendar based on the scheduling data inputted by the buyer or any seller in communication with the system 10. Additionally, it should be recognized that the electronic calendar 19 could be programmed in virtually any number of ways to display an adequate electronic calendar that is capable of being manipulated or modified by a user. For example, the electronic calendar 19 might comprise a plurality of icons 114 that allow for easy manipulation of the calendar or allow the calendar 19 to be displayed on a day-by-day, week-by-week, or month-by-month basis.

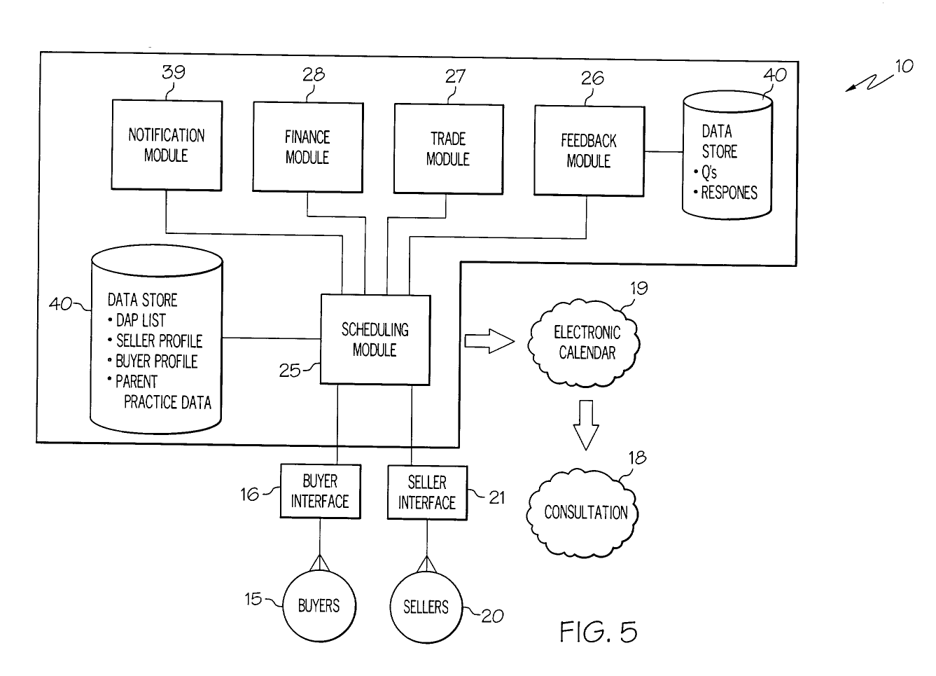

FIG. 5 depicts a more detailed exemplary embodiment of the online scheduling system as depicted in FIGS. 1 and 2. In particular, the online scheduling system 10 of the present invention is illustrated by separate modules, such as, but not limited to, a scheduling module 25, a feedback module 26, a trade module 27, a finance module 28 and a notification module 39, wherein each module of the system comprises an appropriate set of executable instructions or the like. It should be recognized from the foregoing that a system 10, such as that depicted in FIG. 5, and throughout the views, could comprise a single integral set of executable instructions, such as in the form of software, routines, programs, algorithms and/or code, or that portions of these executable instructions could be handled by several components of a system, such as modules working in combination. It is contemplated that the modules of a system 10 could be provided on a single system or multiple systems in various parts of the world to allow efficient access to the system 10 at any time and from any location. Moreover, each module of a system 10 might be provided in communication with each of the other components, such as via a token ring, Ethernet, telephone modem connection, radio or microwave connection, parallel cables, serial cables, telephone lines, universal serial bus “USB”, Firewire, Bluetooth, fiber optics, infrared “IR”, radio frequency “RF”, or combinations thereof.

As depicted in FIG. 5, the online scheduling system 10 of the present invention comprises a scheduling module 25. It is contemplated that the scheduling module 25, will essentially be the “brains” of the system 10 and as such, preferably comprises a processor configured in communication with every module, interface, database or other component associated with or in communication with the system 10. In general, the scheduling module 25 is configured with executable instructions that allow the system 10 to operate and communicate in the desired manner. In an exemplary embodiment of the invention, the scheduling module 25 comprises a server in communication with the Internet.

In the exemplary embodiment of FIG. 5, the scheduling module 25 comprises an electronic calendar 19 that has a plurality of time slots. The scheduling module comprises executable instructions that transmit the electronic calendar 19 to and receive scheduling data from one or more buyer and seller interfaces 16, 21. The buyer indicates time slots on the electronic calendar which are available for scheduling a consultation 18. For example, each buyer 15, such as a physician that registers with the system 10, is provided with a personal electronic calendar 19 that the buyer sets-up and maintains. The buyer inputs data allocating time slots on the electronic calendar 19 which the buyer is available for consultation 18. The electronic calendar 19 is made accessible to sellers, such as sales representatives 20, in communication with the system via a seller interface 21. The sellers 20 select time slots that the buyer 15 has allocated as available. By registering with the system 10, and upon the seller 20 selecting an available time slot, it is understood that the buyer 15 will meet with the seller 20 on the scheduled calendar time and date.

The online scheduling system 10 of the present invention, as depicted in FIG. 5, further comprises a feedback module 26. The feedback module 26 is in communication with the scheduling module 25 and comprises executable instructions configured to transmit to the buyer's interface 16 a plurality of questions relating to the consultation. In more detail, the feedback module 26 comprises a plurality of predetermined questions that are generally related to any consultation 18 between a seller 20 and a buyer 15. Due to the generic nature of the questions, the questions could be transmitted to the buyer's interface 16 at any time before, during or after the consultation 18. In an exemplary embodiment of the invention, the questions in the feedback module 26 are generally presented at the buyer interface 16 following the consultation 18 and are presented in a multiple choice format to make it as simple as possible to collect responses from the buyers. Nonetheless, it should be recognized that the feedback data provided by buyers to the system is not limited to providing responses in the form of multiple-choice questions. In other embodiments, questions presented to the buyers 15 might require more complex answers that are short answer/essay in nature and/or relate to the specific buyer/seller consultation. In another embodiment, the system 10 might not transmit questions to the buyer interface 16, but rather, transmit a blank area for the buyer 15 to provide comments. Lastly, the system 10 might transmit no feedback data form to the buyer interface 16, but might instead accept a buyer's comments from a standard word processing program such as Microsoft Word, WordPerfect, or other program.

It should be recognized from the foregoing that the feedback module 26 further comprises executable instructions configured to receive feedback data in the form of answers to a plurality of questions transmitted to the buyer 15. In an exemplary embodiment of the invention, the seller 20 will receive a copy of the feedback data provided by the buyer 15. Additionally, it should be recognized that the feedback data collected by the feedback module 26 can be organized, analyzed, and possibly sold to companies and/or sellers to assist in marketing and selling their products to buyers.

In the exemplary embodiment of FIG. 5, the online scheduling system 10 further comprises a notification module 39. The notification module 39 is in communication with the scheduling module 25 and comprises executable instructions configured to notify buyers 15 and sellers 20, in communication with the system 10, of a scheduled consultation 18. In particular, the system 10 might send an e-mail or fax alert to the parties at a predetermined time prior to the scheduled date and time (i.e. 24 hours or 48 hours) of the consultation 18. It should be recognized that the notification module 39 could also comprise executable instructions configured to notify parties of a change in schedule made by any of the parties or of a trade between two sellers.

The online scheduling system 10 might further comprise a trade module 27. The trade module 27 is in communication with the scheduling module 25 and comprises executable instructions configured to allow a seller 20 having selected an available time slot on the electronic calendar 19, to trade the time slot for another time slot selected by a different seller or to substitute one seller for another. In particular, in an exemplary embodiment of the invention, the trade module will permit sellers of the same company to trade time slots, or, will permit the substitution of one seller for another from the same company provided the alternate seller is not a part of the buyer's exclusion data. In another embodiment, the trade module 27 will not limit the trading of time slots between sellers of the same company. In this embodiment, the system would allow a seller to trade a time slot with any other seller, or would allow any substitution thereof provided the alternate seller is not a part of the buyer's exclusion data. In this embodiment, it is contemplated that the trade module 27 allows sellers 20 to post the date and time of a scheduled consultation of which they are unable to attend, such that another seller, in communication with the system 10, may indicate a willingness to trade consultation times. It should be recognized from the foregoing that the notification module 39 will notify all the parties of a trade between sellers.

The online scheduling system 10 as depicted in FIG. 5 further comprises a finance module 28. The finance module 28 is in communication with the scheduling module 25 and comprises executable instructions that receive and provide payment to the various parties associated with the system 10. In particular, in an exemplary embodiment of the invention, it is contemplated that sellers 20 might be required to “purchase” a buyer's available time slots on the electronic calendar 19 for the purpose of scheduling a consultation 18. For example, in order to schedule a consultation with a buyer, the seller will be required to provide payment in exchange for being allowed to sign-up for one of the buyer's available time slots. In this embodiment, it is contemplated that the finance module 28 will handle the payment from the seller 20 to the system 10. It should be recognized that the “purchase” option could comprise multiple variations. In one embodiment, a seller 20 might pay for each scheduled consultation 18. In another embodiment, a seller 20 might pay a lump sum for registering with the system 10, or a seller might be required to pay a lump sum for a certain time period or a certain number of consultations.

It is further contemplated that the finance module 28 will comprise executable instructions that provide a payment to the buyer 15 for providing feedback to the system 10. In particular, the online scheduling system 10 of the present invention is designed to reward buyers 15, such as physicians, for responding to a survey relating to the consultation 18 between the buyer and the seller 20. In this embodiment, it is contemplated that the finance module 28 will handle the payment from the system 10 to the buyer 15 once the buyer responds to the survey. Once again, it should be recognized that there are multiple variations of providing payment in exchange for feedback data that could be implemented for the present invention.

FIG. 5 further contemplates that an online scheduling system of the present invention comprise a data store 40 for storing data associated with the system 10. It should be recognized that a data store 40 could comprise multiple data stores in multiple locations, and that a data store 40 could be provided with a back up data store to ensure the system 10 is operable at any time and from any location. It should also be recognized that a data store 40 could be an integral part of the system 10 or could be provided as a separate component in communication with the system 10.

In a non-limiting embodiment of the invention, a data store 40 might comprise data usable by the system 10. For example, a data store 40 might store buyer data such as the buyer's name, address, phone number, e-mail address, social security number and/or the name of the buyer's parent practice including it's name, address, phone number, administrative contact and federal identification number. Moreover, the data store 40 might store each buyer's username and password, exclusion data and any other relevant information. The data store 40 might also comprise data relating to sellers and their respective companies. For example, data stored in the data store 40 might include the seller's name, address, phone number, e-mail and any other relevant information. The data might also include the name of the company they represent and even the types of products the sellers are selling.

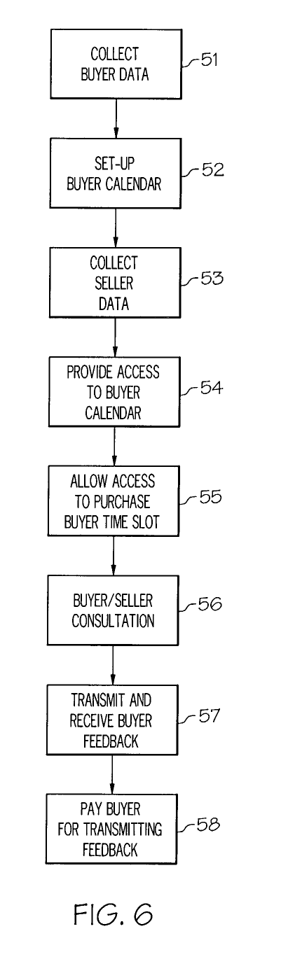

FIG. 6. depicts an exemplary embodiment of a method of using an online scheduling system 10. As will be discussed in more detail, the first step in the method of using an online scheduling system 10 is collecting buyer data (step 51), setting-up each buyer's calendar (step 52) and also collecting seller data (step 53). Following these steps, the sellers that are registered with the system 10 are provided with access (step 54) to the system for locating buyers and selecting and/or purchasing available time slots (step 55) from the buyer's electronic calendar. Next, the buyer and the seller meet in a scheduled consultation (step 56). A plurality of questions are transmitted to the buyer's interface relating to the consultation and responses to the questions, or feedback, is transmitted (step 57) back to the system. Finally, the buyer is paid (step 58) for transmitting the feedback to the system.

The first step in using the online scheduling system, as contemplated by the present invention, is collecting buyer data (step 51). In a non-limiting embodiment of the invention, data collected from the buyer includes the buyer's name, address, phone number, e-mail address and any other relevant information. The data can also include the name of the buyer's parent practice including it's name, address, phone number and administrative contact. Other relevant information might include social security numbers or federal tax identification numbers. It should be recognized that any combination of data could be entered into the system 10. The purpose is simply to identify which buyers are participating.

After the buyer data is collected (step 51), each buyer that is registered with the system 10 might be provided a user name and password that allows them to access the system (step 52) to set-up and/or modify their personalized electronic calendars, view booked consultations, cancellations, confirmations, overbooked time slots and view which competed consultations have not been paid. Initially, a buyer is required to provide available time slots for consultation looking at a predetermined time frame such as a calendar month. In this embodiment, the buyer enters scheduling data into the calendar for allocating available and unavailable time slots to be viewed by sellers.

In addition, a buyer may also have the ability to add exclusion data to the buyer's file. Exclusion data is data that represents particular sellers or particular companies with whom the buyer will not meet, or, with whom the buyer will not meet with representatives of. For example, a buyer might have a personal bias against a particular seller and would prefer not to meet with that person. Additionally, a buyer might not want to meet with any seller from a particular company. In either of these embodiments, a seller, or a seller from a particular company, would not be allowed to book any time slot on the buyer's electronic calendar 19. Additionally, exclusion data might also represent a listing of products that the buyer would prefer not to be solicited. For example, a buyer may particularly like or dislike a product, such as, but not limited to, a pharmaceutical drug for instance, and will not change their mind as to whether they will or will not prescribe such a product. In this embodiment, a seller might not be allowed to book a consultation time if the seller sells that particular type of product.

The next step in the method is collecting seller data (step 53); including data relating to the sellers and their respective companies. For example, data collected from sellers might include the seller's name, address, phone number, e-mail and any other relevant information. The data might also include the name of the company they represent and even the types of products the representatives are selling.

Following input of the required information, each seller registered with the system 10 is provided with a user name and password that allows them to access the system (step 54) to schedule one or more consultations with a buyer. In particular, sellers may be provided with search capabilities to search for buyers they may wish to consult with. Searching may be done by parent practice, buyer name, products prescribed by the buyer, or any other data collected.

After a seller signs-into the system, the system is configured to allow the seller to select one or more available time slots (step 55) from the buyer's electronic calendar. In an exemplary embodiment, a seller will only be allowed to select one appointment per month with each buyer, although this limitation may be easily modified. In particular, a seller might view a buyer's electronic calendar 19 having a plurality of time slots that indicate whether a buyer is available, unavailable, booked, overbooked, cancelled, confirmed or traded. If a slot is available, a seller might input scheduling data into the system and select the particular available time slot for the desired consultation time. If a time slot is already booked by another seller 20, the seller can overbook the time slot with the hope that the first seller will cancel. In such a scenario, the overbooked time slot will defer to the second seller in-line, and the second seller will then be able to meet with the buyer at the scheduled time. Also, if a particular time slot has been booked by another seller, the seller could seek to trade time slots through the trade module.

After an available time slot is selected by the seller, a consultation 18 is scheduled and the two parties meet on the scheduled date and time. Following the consultation 18, a plurality of questions generally relating to the consultation are transmitted to the buyer interface 16. The buyer responds to the questions, and transmits the feedback data (step 57) back to the system 10. Following the system's 10 acceptance of the buyer's feedback data, the buyer is paid (step 58) for transmitting the feedback data to the system.

It should be recognized from the foregoing, that the feedback data could comprise any type of information that is relevant to the seller/buyer consultation 18. The feedback data could be collected for the purpose of providing feedback to the individual seller and their respective companies for ways to improve the selling or soliciting process. In one embodiment of the invention, this data is collected and sold to the companies to help create better marketing and sales presentations.

As stated above, those skilled in the relevant art will appreciate that the present on-line scheduling system could be used in virtually any industry, particularly wherein sellers and buyers communicate through a solicitation process. Accordingly, while exemplary embodiments within the specification may describe the solicitation of prescription drugs and/or products through the scheduled consultation of pharmaceutical sales representatives and physicians, those skilled in the art will understand and appreciate that such on-line scheduling methods may be adopted by other similar industries. Thus, the scope of the present invention is not intended to be limiting herein.

Advantages and improvements of the systems and methods of the present invention are demonstrated in the following example. This example is illustrative only and is not intended to limit or preclude other embodiments of the invention.

### EXAMPLE 1

In this example, an on-line scheduling consultation is conducted between a pharmaceutical sales representative and a physician. According to this example, a physician connects to a software operated web-site hosted on a network, such as a wide area network, local area network, or the Internet. The physician establishes an account and/or profile with the operator of the host network by providing information required by the network operator, including but not limited to, for instance, their name, address, social security number, employment data, etc. In exemplary embodiments, the physician may also be required to provide payment to register with the system. After establishing an account, the physician is granted access to various portions of the system to modify and/or enter data as needed. The physician is also permitted to maintain an electronic calendar displaying their availability for scheduling a sales consultation with registered sellers affiliated with the operator.

After the physician establishes their calendar, a registered pharmaceutical sales representative logs into the host network by entering a pre-established username and password. The pharmaceutical sales representative searches the software database for registered physicians to select a time and date to schedule a consultation with such physician. The sales representative locates a physician and schedules a consultation by entering and submitting a consultation request into the physician's electronic calendar. After the consultation is scheduled, a notification (such as an email) is sent by the system to both the pharmaceutical sales representative and the physician confirming the pre-determined consultation date and time. The pharmaceutical sales representative and physician meet at the scheduled date and time to conduct the consultation. The physician completes a feedback form answering predetermined questions and/or provides comments regarding the consultation and submits the same through the network after meeting for the consultation with the pharmaceutical sales representative. The feedback data is received and acknowledged by the system through the network whereby the physician is then rendered payment in exchange for submitting such feedback.

Having shown and described the preferred embodiments of the present invention, further adaptations of the online scheduling system of the present invention as described herein can be accomplished by appropriate modifications by one of ordinary skill in the art without departing from the scope of the present invention. Several of these potential modifications and alternatives have been mentioned, and others will be apparent to those skilled in the art. For example, while exemplary embodiments of the system have been discussed for illustrative purposes, it should be understood that the elements described will be constantly updated and improved by technological advances. Accordingly, the scope of the present invention should be considered in terms of the following claims and is understood not to be limited to the details of structure, operation or process steps as shown and described in the specification and drawings.

What is claimed is:

1. An online scheduling system comprising:
a scheduling module comprising an electronic calendar having a plurality of time slots, the scheduling module comprising executable instructions configured to transmit the electronic calendar to and receive scheduling data from one or more buyer and seller interfaces in order to facilitate a scheduling of a consultation between a buyer and a seller; and
a feedback module in communication with said scheduling module, said feedback module comprising executable instructions configured to receive feedback data from a buyer interface following a scheduled consultation.

2. The online scheduling system of claim 1, wherein said feedback module comprises a plurality of questions relating to a scheduled consultation.

3. The online scheduling system of claim 2, wherein said feedback module comprises executable instructions configured to transmit said plurality of questions to a buyer interface and comprises executable instructions configured to receive a response to at least one of said plurality of questions.

4. The online scheduling system of claim 1, further comprising a notification module in communication with said scheduling module and having executable instructions configured to notify one or more buyers and sellers in communication with said system of a scheduled consultation.

5. The online scheduling system of claim 1, wherein the scheduling data comprises a buyer's indication of one or more available time slots on said electronic calendar for scheduling a consultation.

6. The online scheduling system of claim 5, wherein the scheduling data comprises a seller's selection of one or more available time slots on said electronic calendar.

7. The online scheduling system of claim 6, further comprising a finance module in communication with said scheduling module and having executable instructions configured to receive payment from a seller based on a seller's selection of available time slots.

8. The online scheduling system of claim 7, wherein said finance module further comprises executable instructions configured to provide payment to a buyer for providing feedback data to said feedback module.

9. The online scheduling system of claim 6, further comprising a trade module in communication with said scheduling module having executable instructions configured to allow a seller having selected an available time slot on said electronic calendar to trade the time slot for another time slot selected by a different seller.

10. The online scheduling system of claim 1, further comprising a data store in communication with said scheduling module and configured to receive exclusion data from a buyer interface.

11. The on-line scheduling system of claim 10, wherein said scheduling module is configured with executable instruction that prevent a seller identified on the exclusion data from scheduling a consultation with a buyer.

12. A method of collecting data for an online scheduling system comprising the steps of:
transmitting to a seller interface an electronic calendar comprising scheduling data indicative of one or more available time slots of a buyer for a scheduled consultation;
receiving scheduling data from the seller interface comprising a seller's selection of one or more available time slots on said electronic calendar for scheduling a consultation; and
receiving feedback data from the buyer after the scheduled consultation.

13. The method of collecting data according to claim 12, further comprising the step of transmitting a plurality of questions to a buyer's interface.

14. The method of collecting data according to claim 13, wherein said feedback data comprises a response to at least one of the plurality of questions.

15. The method of collecting data according to claim 12, further comprising the step of notifying one or more buyer and seller in communication with said system of a scheduled consultation.

16. The method of collecting data according to claim 12, further comprising the step of receiving payment from a seller based on a seller's selection of available time slots.

17. The method of collecting data according to claim 12, further comprising the step of providing payment to a buyer for providing feedback data to said system.

18. The method of collecting data according to claim 12, further comprising the step of allowing a seller having selected an available time slot on said electronic calendar to trade the time slot for another time slot selected by a different seller.

19. The method of collecting data according to claim 12, further comprising the step of preventing a seller identified on exclusion data from scheduling a consultation with a buyer.

20. A computer readable medium containing instructions for controlling a computer system for providing an online scheduling system, by:
transmitting to a seller interface an electronic calendar comprising scheduling data indicative of one or more available time slots of a buyer for a scheduled consultation;
receiving scheduling data from the seller interface comprising a seller's selection of one or more available time slots on said electronic calendar for scheduling a consultation; and
receiving feedback data from the buyer after the scheduled consultation.

21. The computer readable medium of claim 20, further comprising the instruction of transmitting a plurality of questions to a buyer's interface.

22. The computer readable medium of claim 20, further comprising the instruction of receiving payment from a seller based on a seller's selection of available time slots.

23. The computer readable medium of claim 20, further comprising the instruction of providing payment to a buyer for providing feedback data to said system.

24. The computer readable medium of claim 20, further comprising the instruction of preventing a seller identified on exclusion data from scheduling a consultation with a buyer.

25. A network-based method for providing an on-line scheduling system comprising the steps of:
providing a web-site accessible by at least one buyer and at least one seller;
transmitting to a seller interface an electronic calendar comprising scheduling data indicative of one or more available time slots of a buyer for a scheduled consultation;
receiving scheduling data from the seller interface comprising a seller's selection of one or more available time slots on said electronic calendar for scheduling a consultation; and
receiving feedback data from the buyer after the scheduled consultation.

26. The network-based method for providing an on-line scheduling system according to claim 25, further comprising the step of:
receiving a payment from the seller in exchange for allowing the seller to purchase an available time slot on said electronic calendar.

27. The network-based method for providing an on-line scheduling system according to claim 25, further comprising the step of:
providing a payment to the buyer in exchange for the buyer providing feedback relating to the consultation.
